(19) United States
(12) Patent Application Publication
(10) Pub. No.: US 2022/0117170 A1
(43) Pub. Date: Apr. 21, 2022

(54) HINGED PLANTER BOX

(71) Applicant: Frank Barcik, Hackettstown, NJ (US)

(72) Inventor: Frank Barcik, Hackettstown, NJ (US)

(21) Appl. No.: 17/447,124

(22) Filed: Sep. 8, 2021

Related U.S. Application Data
(60) Provisional application No. 63/198,439, filed on Oct. 19, 2020.

(51) Int. Cl. A01G 9/28; B65D 6/18

(52) U.S. Cl. CPC A01G 9/28; B65D 9/14

(57) ABSTRACT

A planter box includes side panels joined with hinges. The planter box unfolds into a polygon in a deployed position and folds into a flat storage position.

### CROSS-REFERENCE TO RELATED APPLICATION

This application claims the benefit of priority of U.S. provisional application No. 63/198,439, filed Oct. 19, 2020, the contents of which are herein incorporated by reference.

### BACKGROUND OF THE INVENTION

The present invention relates to a planter box and, more particularly, to a hinged planter box.

Often, to plant a garden, flower bed, or compost pile, the gardener must dig up their yard. One alternative to digging up the yard is to place a raised bed on the property. However, currently available devices are very bulky and heavy and pose difficulty in shipping and set up. Moreover, they cannot be folded for storage in cold weather.

As can be seen, there is a need for an easily set up and stored raised planting bed.

### SUMMARY OF THE INVENTION

The present invention provides a hinged planter box having side panels with interlocking hinges at each corner. The gardener may fill the planter box with topsoil and plant whatever they like without digging up the yard. The hinges additionally allow the gardener to set the planter box up in a substantially square or a substantially diamond-shaped pattern, for example, to fit in a limited space. The side panels with interlocking hinges at each corner makes the inventive planter box easy to setup, to store, and to fit into a tight space.

The inventive planter boxes may also be stacked to accommodate a mulch pile, including leaves, weeds, etc., or the stacked boxes may be used for storage.

In one aspect of the present invention, a planter box is provided comprising hingedly joined side panels configured to unfold into a polygon in a deployed position and to fold into a substantially planar storage position.

These and other features, aspects and advantages of the present invention will become better understood with reference to the following drawings, description, and claims.

### BRIEF DESCRIPTION OF THE DRAWINGS

FIG. 1 is a perspective view of a hinged planter box according to an embodiment of the invention;

FIG. 2 is another perspective view thereof;

FIG. 3 is an exploded perspective view thereof; and

FIG. 4 is an exploded perspective view of the hinge assembly thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

Broadly, one embodiment of the present invention is a hinged planter box comprising a plurality of side panels interconnected with hinges.

The side panels may be manufactured from any suitable material, including wood. The side panels may comprise rectangular planar boards. Each side panel may have multiple boards stacked one above the other (e.g., about two vertically stacked boards). The boards may be any suitable size, such as about 24″ long or more by about 3½″ tall by about ¾″ thick. The number of side panels may be 4 for a square or diamond-shaped planter. However, in some embodiments, three, five, six, seven, or eight side panels may be combined to achieve other polygon shapes in a deployed position.

The side panels may be attached to each other with interlocking corner hinges. In other words, the side panels are hingedly joined. Each corner hinge generally has a flat side with about four screw holes. The corner hinges may be aligned with the top section or a top edge on each the left and right side of each side panel. The flat side of the hinge forms a tab that extends beyond the bottom portion of the side panel by, for example, about 1⅝ inch. Preferably, the hinges are right-angle hinges. The hinges may be manufactured of any suitable material, such as a metal. The hinges allow the box to be folded into a substantially flat position for storage, i.e., into a substantially planar storage position, and to be unfolded or opened and set up in a square or diamond type pattern deployed position.

Each hinge leaf may be fastened to a side panel using a plurality of screws. For example, about four screws for each hinge leaf, about eight screws per side panel, for a total of about thirty-two screws for a planter box. The screws may be, for example, sharp point lath screws. Any suitable screw size may be used, such as about ⅛-inch diameter by ¾-inch-long.

The hinge leaves may be secured together using pins, i.e., the hinge leaves may be pivotally coupled around a pin. Any suitable pin may be used, such as pins of about 7-inch-long by about ⅛-inch diameter. The material of manufacture is not particularly limited and may be, for example, steel.

To use, a gardener may set the planter box on the ground and push down on each corner to press the extended end of each metal hinge into the ground, securing the planter box thereto.

Stacked planter boxes may be secured by the flat side tabs of the hinges extending below the side panels, thereby interlocking the boxes together, i.e., each tab is configured to interlock with an upper portion of another hinge leaf.

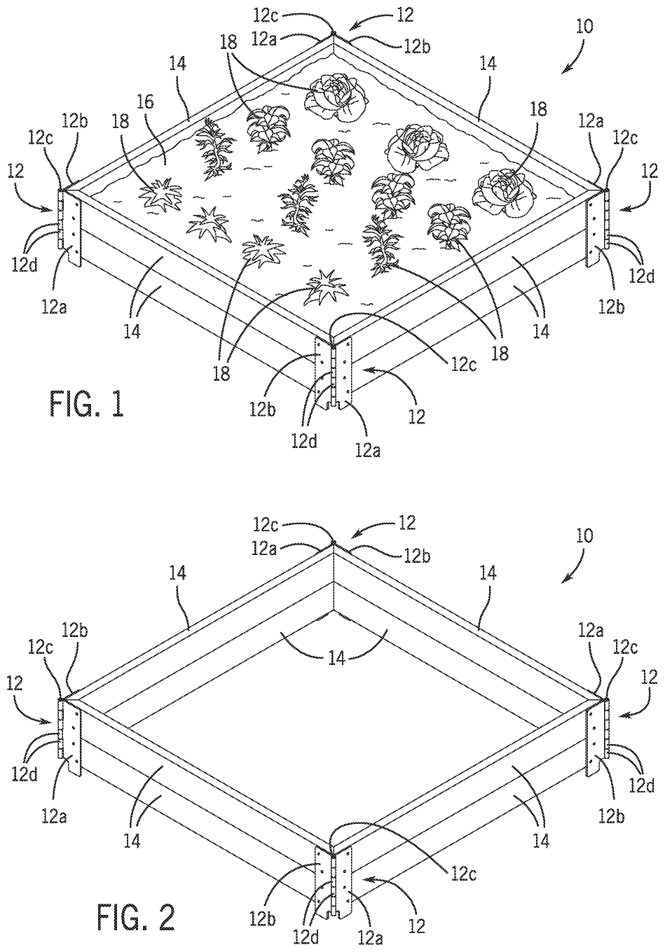

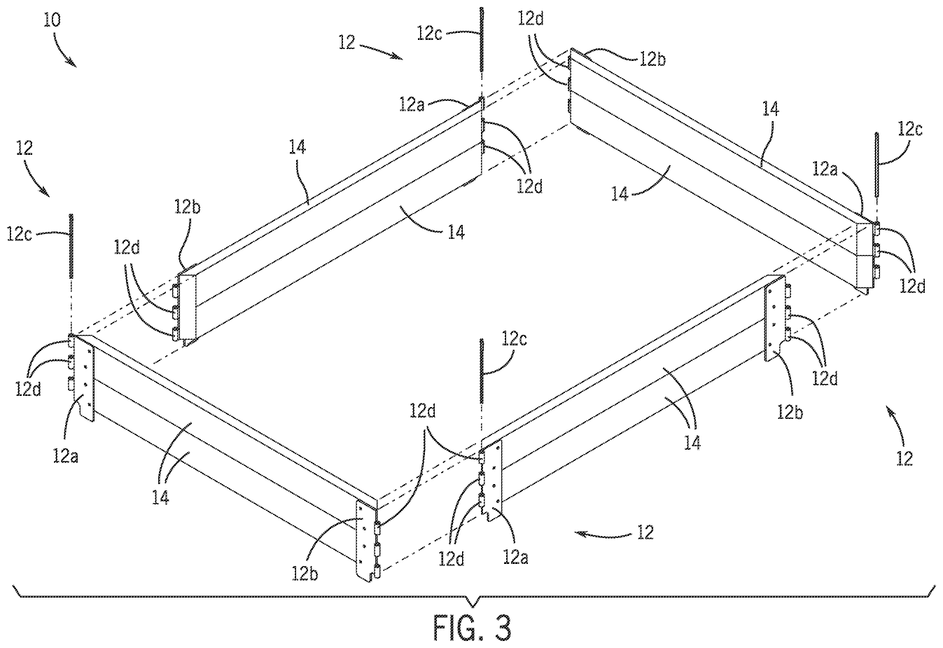

Referring to FIGS. 1-4, FIGS. 1-2 show a hinged planter box 10 according to an embodiment of the present invention, having 4 side panels 14 with a right-angle interlocking corner hinge assembly 12 at each corner. FIG. 1 shows the hinged planter box in use, containing topsoil 16 with plants 18 planted therein. As shown in FIG. 3, the side panels 14 may be disconnected from each other by removing the hinge pin 12c at each corner.

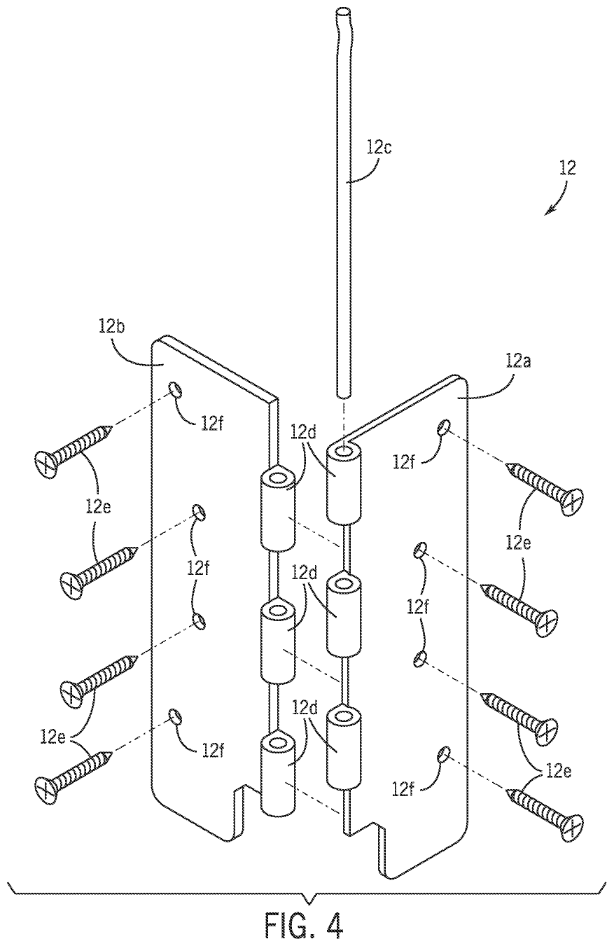

FIG. 4 provides an enlarged view of a hinge assembly 12, comprising a first hinge leaf 12a and a second hinge leaf 12b, each having hinge knuckles 12d through which the hinge pin 12c alternately passes. The hinge assembly 12 may be secured to a pair of side panels 14 with screws 12e inserted through holes 12f in the hinge leaves 12a, 12b.

It should be understood, of course, that the foregoing relates to exemplary embodiments of the invention and that modifications may be made without departing from the spirit and scope of the invention as set forth in the following claims.

What is claimed is:

1. A planter box comprising hingedly joined side panels configured to unfold into a polygon in a deployed position and to fold into a substantially planar storage position.

2. The planter box of claim 1, wherein the hingedly joined side panels comprise a first rectangular wall, a second rectangular wall hingedly coupled to the first rectangular wall, a third rectangular wall hingedly coupled to the second rectangular wall, and a fourth rectangular wall hingedly coupled to the third rectangular wall, with the first rectangular wall hingedly coupled to the fourth rectangular wall.

3. The planter box of claim 1, wherein the hingedly joined side panels each comprise vertically stacked boards with a first hinge leaf fastened to a first end of the vertically stacked boards and a second hinge leaf fastened to a second end of the vertically stacked boards, wherein the first hinge leaf and the second hinge leaf align with a top edge of the vertically stacked boards.

4. The planter box of claim 3, wherein the first hinge leaf is pivotally coupled around a pin to a third hinge leaf, the second hinge leaf is pivotally coupled around a pin to a fourth hinge leaf, and the first hinge leaf, the second hinge leaf, the third hinge leaf, and the fourth hinge leaf each has a tab that extends beyond a bottom portion of the vertically stacked boards.

5. The planter box of claim 4, wherein the planter box includes a first planter box stacked upon a second planter box and each tab of the first planter box is configured to interlock with hinge leaves of the second planter box.

6. The planter box of claim 4, wherein the first hinge leaf and the third hinge leaf form a right-angle hinge and the second hinge leaf and the fourth hinge leaf form a right-angle hinge.
